(19) United States
(12) Patent Application Publication
(10) Pub. No.: US 2022/0146057 A1
(43) Pub. Date: May 12, 2022

(54) LIGHTING DEVICE AND BULB

(71) Applicant: Hangzhou Hangke Optoelectronics Group Co., Ltd., Hangzhou (CN)

(72) Inventors: Qianjun Yan, Hangzhou (CN); Zhaozhang Zheng, Hangzhou (CN); Lingli Ma, Hangzhou (CN)

(73) Assignee: Hangzhou Hangke Optoelectronics Group Co., Ltd., Hangzhou (CN)

(21) Appl. No.: 17/112,028

(22) Filed: Dec. 4, 2020

(30) Foreign Application Priority Data
Nov. 6, 2020 (CN) 202011230118.5

(51) Int. Cl. F21K 9/238; F21K 9/232; F21V 29/56

(52) U.S. Cl. CPC F21K 9/238; F21Y 2115/10; F21V 29/56; F21K 9/232

(57) ABSTRACT

A light-emitting device and a bulb include a light engine structure. The light engine structure includes a first seal cavity and a light source which is provided in the first seal cavity. The first seal cavity filled with an insulating liquid or gas. The light source is exposed to the insulating liquid or gas. A second seal cavity is provided outside the first seal cavity, which is filled with an insulating liquid or gas. This invention provides a sealed light-emitting engine filled with heat-dissipating liquid or gas, in which a second layer of sealed heat-dissipating structure is disposed outside the light-emitting engine, and the die structure exposed to the heat-dissipating liquid or gas, which solves the heat-dissipating problem of lamps. Furthermore, a design of the light-emitting engine provides a foundation for various applications of bulb lamps, and solves defects of cost and light efficiency of common bulb lamps at present.

### CROSS-REFERENCE TO RELATED APPLICATIONS

This Non-provisional application claims priority under 35 U.S.C. § 119(a) to Chinese Patent Application No. 202011230118.5 filed on Nov. 6, 2020, the entire content of which is hereby incorporated by reference in its entirety.

### TECHNICAL FIELD

The invention belongs to a field of illumination technology, and particularly relates to an LED lighting device and a bulb.

### BACKGROUND ART

Light-Emitting Diode (called as LED for short) is widely applied in displaying, general lighting and other fields due to its characteristics such as energy saving, environmental protection, long life and small size and the like. Technologies in the LED industry are becoming more and more mature, its application is becoming wider and wider, and its market demand is large, and it gradually replaces traditional high-pressure halogen lamps, tungsten lamp and even energy-saving lamps, so as to truly save energy and reduce emissions and green the earth. Currently, in order to meet needs of different application fields, LED packaging technology is continually improved and a form of a LED light source is increasingly diversified.

For a conventional bead-type LED lamp, it is difficult to completely replace a conventional incandescent lamp and achieve a full-light-distribution illumination due to characteristics of the LED lighting such as its point light source and directionality.

In recent years, a popular LED filament lamp can achieve a light distribution close to that of the incandescent lamp. However, with a conventional straight hard filament, the filament lamp is with a limitation in its style for the filament's nature, and a flexible filament can be made in different styles, but it has defects of a low luminous flux and a low luminous efficiency.

In realizing a light distribution close to that of the incandescent lamp and improving the light efficiency, a heat dissipation issue is also the one that needs to be solved. LED is a semiconductor device, and the luminous efficiency will rapidly degrade and even its P-N junction will be burned when a junction temperature of the P-N junction increases. Up to now, the heat dissipation issue is still the one that needs to be solved for a long period in using a low-voltage and high-current power LED lighting lamp, particularly relating to the LED filament lamp.

### SUMMARY

Technical problems to be solved by this invention is to provide a sealed light-emitting engine filled with heat-dissipating liquid or gas, in which a second layer of sealed heat-dissipating structure is disposed outside the light-emitting engine, and meanwhile a light source is in an LED die structure exposed to the heat-dissipating liquid or gas, which well solves the heat-dissipating problem of LED lamps; in addition, a conceptual design of the light-emitting engine provides a foundation for various applications of LED bulb lamps, and solves defects of cost and light efficiency of common bulb lamps at present.

In order to solve the above technical problems, the invention adopts the following technical scheme:

A light-emitting device includes a light engine structure. The light engine structure includes a light source and a first seal cavity. The light source is provided in the first seal cavity, and the first seal cavity is filled with an insulating liquid or gas. The light source in the first seal cavity is exposed to the insulating liquid or gas. A second seal cavity is provided outside the first seal cavity, and the second seal cavity is filled with an insulating liquid or gas.

The light source includes a pin which extends from the first seal cavity to the second seal cavity. The first seal cavity and the second seal cavity are light-permeable seal cavities.

As one of the embodiments, the light source includes a plurality of light-emitting diodes and a substrate. The light-emitting diodes are arranged on the substrate and are connected in series, parallel, or a combination of series and parallel. An end of the pin is connected with the substrate.

As one of the embodiments, the light source includes a die structure which is exposed to the insulating liquid or gas in the first seal cavity.

As one of the embodiments, the light-emitting device further includes a driving circuit which is arranged on the substrate. An end of the pin is connected with the driving circuit, and the other end of the pin is located in the second seal cavity.

As one of the embodiments, the light source is connected with a driving circuit which is arranged in the second seal cavity. And the pin located in the second seal cavity is connected with the driving circuit.

As one of the embodiments, a plurality of die structures is connected in series, parallel, or a combination of series and parallel to form a chain light source.

As one of the embodiments, the chain light source is wound around the substrate.

As one of the embodiments, the chain light source includes one or more strip-shaped substrates on which the die structures are arranged in series or in parallel or in a combination of series and parallel, and the chain light source on each of the strip-shaped substrates is a light source with a same color temperature or with different color temperatures.

As one of the embodiments, the light source comprises a plurality of light source groups, and color temperatures of respective ones of the light source groups are the same or different.

As one of the embodiments, a lens structure is provided in a housing of the first seal cavity, or a part of the housing of the first seal cavity is the lens structure.

As one of the embodiments, an inner surface of the housing of the first seal cavity is partially provided with a reflective coating.

As one of the embodiments, the housing of the first seal cavity or the housing of the second seal cavity is provided with a fluorescent powder or a diffusion powder, or a combination of the fluorescent powder and the diffusion powder.

As one of the embodiments, the insulating liquid is a liquid with a high heat capacity and light permeability.

As one of the embodiments, the insulating liquid is a high temperature liquid.

As one of the embodiments, a heat conducting structure is provided in the first seal cavity, and the heat conducting structure is exposed to the insulating liquid or gas.

As one of the embodiments, the housing of the first seal cavity is made of silica gel or plastics, and the housing of the second seal cavity is made of glass.

A bulb includes the light-emitting device described above, and further includes a stem and a base. The base and the stem are connected with the housing of the second seal cavity. The base is used for receiving an external power supply. The housing of the first seal cavity is fixed on the stem.

As one of the embodiments, the stem includes a flare tube, a flare base, an electric lead and an exhaust pipe. The exhaust pipe is arranged in the flare tube, the flare base is hermetically connected to the second seal cavity. An end of the electric lead is connected to the base and the other end of the electric lead is connected to the pin.

As one of the embodiments, the bulb further includes a driving circuit, the driving circuit is installed in the base, or in the first seal cavity, or in the second seal cavity.

As one of the embodiments, the bulb further includes an intelligent driving module installed in the base. The intelligent driving module includes a controller and a communication module.

Compared with the prior art, the invention provides the following beneficial effects.

According to the invention, the covering glue in a traditional LED chip structure is removed, and on this basis a seal cavity is designed as a light source to replace the existing light source with a filament structure. A heat dissipation effect is greatly improved compared with the existing light source with the filament structure, a corresponding controllable range of power is larger, and different products with a wider range of light intensity can be manufactured. Meanwhile, based on the technical scheme, a structure with a smaller volume can be realized.

Other beneficial effects are further described in the section on embodiments.

### BRIEF DESCRIPTION OF DRAWINGS

FIG. 1 is a schematic structural diagram of a first seal cavity;

FIG. 2 is a schematic structural diagram of a first seal cavity with a light source driving circuit;

FIG. 3 is a schematic diagram of a bulb structure according to Embodiment 2;

FIG. 4 is a schematic diagram of a bulb structure according to Embodiment 3;

FIG. 5 is a schematic diagram of a bulb structure according to Embodiment 4;

FIG. 6 is a schematic diagram of another bulb structure according to Embodiment 4;

FIG. 7 is a schematic diagram of the bulb structure with a heat conducting structure according to embodiment 5; and

FIG. 8 is a schematic diagram of another bulb structure with a heat conducting structure.

### DETAILED DESCRIPTION OF PREFERRED EMBODIMENTS

The application will be further described in detail with reference to the drawings and embodiments. It can be understood that the specific embodiments described herein are only intended to explain related inventions, but not to limit the invention. In addition, it should also be noted that for convenience of description, only the parts related to the invention are shown in the drawings. Terms such as “first” and “second” mentioned in the present invention are provided for the convenience of describing the technical scheme of the present invention, have no specific limiting function, are all general terms and do not constitute a limiting for the technical scheme of the present invention. It should be noted that the embodiments in the present application and the characteristics in the embodiments can be combined mutually in the case of no conflict. The present invention will be described in details with reference to drawings and in combination with embodiments.

### Embodiments 1

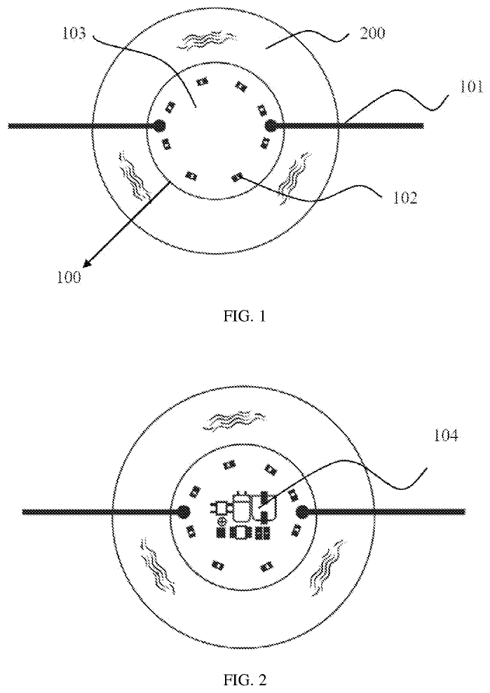

As shown in FIG. 1, a light-emitting device includes a light engine structure. The light engine structure includes a light source 100 and a first seal cavity 200. The light source is provided in the first seal cavity and filled with an insulating liquid. The light source in the first seal cavity is exposed to the insulating liquid. A second seal cavity 300 is provided outside the first seal cavity, and the second seal cavity is filled with an insulating gas.

The light source includes a pin 101 which extends from the first seal cavity to the second seal cavity.

The first seal cavity is a translucent light-permeable seal cavity, and the second seal cavity is a fully transparent light-permeable seal cavity. A translucent light-permeable material is equivalent with a transparent material in light permeability, but the translucent material can reduce a glare from the light source. Using fully transparent materials outside the first seal cavity, a structure of the inner first seal cavity can be observed, which is beautiful.

Specifically, the light source includes a plurality of light-emitting diodes 102 and a substrate 103. The light-emitting diodes are arranged on the substrate and are connected in series, parallel, or a combination of series and parallel. An end of the pin is connected with the substrate.

The light emitting diode has a die structure which is exposed to the insulating liquid in the first seal cavity.

In a traditional scheme, a surface of the die structure needs to be covered with glue for dustproof and anticorrosion. According to the present technical scheme, the covering glue on the surface of the traditional light emitting diode is removed, and disturbance of heat dissipation is reduced. Meanwhile, the die is protected by a sealing device, and the heat dissipation of the die structure can be directly made by the insulating liquid.

The first seal cavity is a cavity for placing a light source, and the second seal cavity is a protection cavity or a secondary heat dissipation cavity.

As shown in FIG. 2, in this embodiment, there is a driving circuit 104 which is arranged on the substrate in the first seal cavity, and an end of the pin is connected with the driving circuit, and the other end of the pin is located in the second seal cavity.

With the driving circuit of this embodiment, the first seal cavity can be directly connected to an external power supply. In a special embodiment, the first seal cavity as an independent light source is connected in series or in parallel through power lines to form various application modes.

The insulating liquid (or inert liquid) is injected into the first seal cavity to serve as a heat dissipation or heat conduction material, which is required to have characteristics of high refractive index, thermal conductivity, insulation and low viscosity, such as silica gel and silicone oil. Furthermore, the insulating liquid is required to have high heat resistance, so as to ensure that performance and colors will not deteriorate when heated (lighted) for a long time.

The second seal cavity is filled with an inert gas, preferably helium or a mixed gas with helium. On this base, the first seal cavity is directly exposed in the second seal cavity, and helium or the mixed gas with helium in the second seal cavity continuously dissipates heat from the first seal cavity.

In this embodiment, the first seal cavity is made of silica gel or plastic, with a high light transmittance. The second seal cavity is made of glass. Preferably, the housing of the first seal cavity is made of a material with excellent thermal conductivity or a thickness of the housing is designed to be thinner.

Since the first seal cavity is filled with the liquid, a glass material is no longer applicable to the first seal cavity due to its fragile property, and it is preferable to use a non-fragile and light-permeable material. Moreover, because a large size of a liquid molecule, use of the silica gel or plastic material will not affect a sealing performance. The second seal cavity is made of glass, and the glass is more suitable for the second seal cavity filled with helium or the mixed gas with helium for its less deformation and better sealing performance.

Based on the above structure of this embodiment, the first seal cavity serves as the light engine structure, which can minimize a size of the light engine, and is different from the existing LED filament structure (an actual projection area of the light source inside the LED filament lamp is large and unsightly). In this embodiment, the first seal cavity serves as a light engine with a housing, and thus various application variations can be made to the first seal cavity. It solves problems such as limitation on various application variations to a lamp shell of the bulb, and cost.

The housings of the first seal cavity and the second seal cavity can be provided with a fluorescent powder or a diffusion powder; and meanwhile, the housing can be transparent or colored. At the same time, a shape of the first seal cavity can be spherical, pentagonal, columnar, etc., and a shape of the second seal cavity can also be adjusted according to actual application requirements.

In the following, advantages of applying the liquid heat dissipation and LED die structure are further demonstrated by experimental data.

Table 1 shows the current and cold-heat ratio for the die structure in the first seal cavity structure filled with the gas or liquid (without the second seal cavity) compared with a conventional LED lamp filled with the gas or liquid, in a case of no supplied current.

| | | 13 ma | | 20 ma | | 26 ma | | 33 ma | | 40 ma | |
|---|---|---|---|---|---|---|---|---|---|---|---|
| | Filament | Cold-Heat | | Cold-Heat | | Cold-Heat | | Cold-Heat | | Cold-Heat | |
| | Type | Ratio | Note | Ratio | Note | Ratio | Note | Ratio | Note | Ratio | Note |
| with | Chip Area | 88.56% | OK | 74.42% | NG | 58.03% | Failed | Failed | | Failed | |
| Covering | of | | | | | | | | | | |
| Glue + | 3008-LED | | | | | | | | | | |
| Helium in | 100 mil² * 24 | | | | | | | | | | |
| the Lamp | Chip Area | 90.11% | OK | 78.75% | NG | 64.57% | Failed | Failed | | Failed | |
| Shell | of | | | | | | | | | | |
| | 3008-LED | | | | | | | | | | |
| | 200 mil² * 24 | | | | | | | | | | |
| | Chip Area | 93.85% | OK | 86.36% | OK | 76.05% | NG | 58.18% | Failed | Failed | |
| | of | | | | | | | | | | |
| | 3008-LED | | | | | | | | | | |
| | 300 mil² * 24 | | | | | | | | | | |
| with | Chip Area | 92.48% | OK | 81.77% | NG | 70.07% | NG | Failed | | Failed | |
| Covering | of | | | | | | | | | | |
| Glue + | 3008-LED | | | | | | | | | | |
| Liquid in | 100 mil² * 24 | | | | | | | | | | |
| the Lamp | Chip Area | 92.74% | OK | 85.15% | OK | 75.58% | NG | Failed | | Failed | |
| Shell | of | | | | | | | | | | |
| | 3008-LED | | | | | | | | | | |
| | 200 mil² * 24 | | | | | | | | | | |
| | Chip Area | 95.37% | OK | 90.62% | OK | 84.81% | OK | 74.92% | NG | 61.27% | Failed |
| | of | | | | | | | | | | |
| | 3008-LED | | | | | | | | | | |
| | 300 mil² * 24 | | | | | | | | | | |
| Die | Chip Area | 100.15% | OK | 89.85% | OK | 67.26% | NG | Failed | | Failed | |
| Structure + | of | | | | | | | | | | |
| Helium | 3008-LED | | | | | | | | | | |
| in the | 100 mil² * 24 | | | | | | | | | | |
| Lamp | Chip Area | 100.97% | OK | 100.50% | OK | 98.31% | OK | 93.02% | OK | 73.31% | NG |
| Shell | of | | | | | | | | | | |
| | 3008-LED | | | | | | | | | | |
| | 200 mil² * 24 | | | | | | | | | | |
| | Chip Area | 102.96% | OK | 103.89% | OK | 103.88% | OK | 102.40% | OK | 97.59% | |
| | of | | | | | | | | | | |
| | 3008-LED | | | | | | | | | | |
| | 300 mil² * 24 | | | | | | | | | | |
| Die | Chip Area | 102.17% | OK | 102.08% | OK | 100.32% | OK | 96.84% | OK | 54.89% | Failed |
| Structure + | of | | | | | | | | | | |
| Liquid | 3008-LED | | | | | | | | | | |
| in the | 100 mil² * 24 | | | | | | | | | | |
| Lamp | Chip Area | 101.33% | OK | 101.29% | OK | 100.16% | OK | 97.58% | OK | 90.74% | OK |
| Shell | of | | | | | | | | | | |
| | 3008-LED | | | | | | | | | | |
| | 200 mil² * 24 | | | | | | | | | | |
| | Chip Area | 102.66% | OK | 103.02% | OK | 103.63% | OK | 103.69% | OK | 103.53% | OK |
| | of | | | | | | | | | | |
| | 3008-LED | | | | | | | | | | |
| | 300 mil² * 24 | | | | | | | | | | |

In the table, OK indicates that the data index is qualified, NG indicates that the data index is unqualified, and Failed indicates that the lamp product is failed.

It can be seen from the above data comparison that:

1. Compared with “with covering glue+gas”, the maximum current of “die structure+gas” can be increased to more than 1.5˜2.5 times depending on different chip sizes.

2. Compared with “with covering glue+liquid”, the maximum current of “die structure+liquid” can be increased to more than 1.5˜3.0 times depending on different chip sizes.

### Embodiments 2

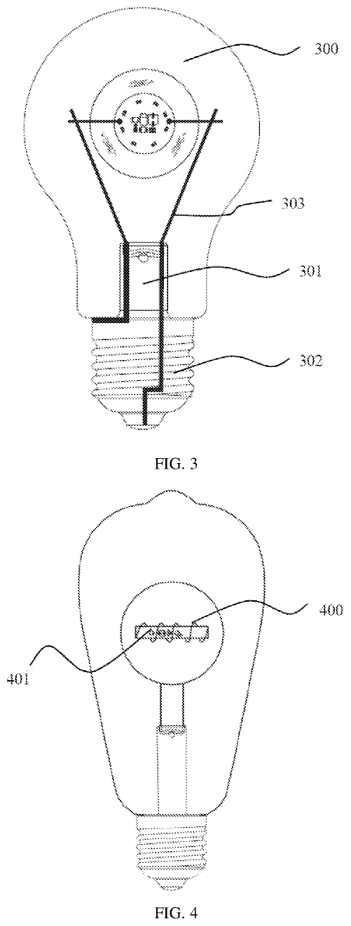

This embodiment discloses a bulb. As shown in FIG. 3, the bulb includes the light-emitting device described in Embodiment 1, and further includes a stem 301 and a base 302. The base and the stem are connected to the housing of the second seal cavity 300 (i.e., the lamp shell of the bulb), and the base is used for receiving an external power supply. A housing of the first seal cavity is fixed to the stem.

The stem includes a flare tube, a flare base, an electric lead 303 and an exhaust pipe. The exhaust pipe is arranged in the flare tube, the flare base is hermetically connected to the second seal cavity. An end of the electric lead is connected to the base and the other end of the electric lead is connected to the pin.

In another embodiment, a driving circuit is provided in the second seal cavity. The pin located in the second seal cavity is connected with the driving circuit.

Or, in another embodiment, there is a driving circuit which is arranged in the base. The pin is led out of the first seal cavity, and the other end of the pin is connected with the driving circuit in the base.

Furthermore, it further includes an intelligent driving module installed in the base. The intelligent driving module includes a controller and a communication module. The communication module can be a wireless communication module such as a Bluetooth module, a WiFi module and a zigbee module. In this way, an intelligent control function or a lighting effect control function and the like can be achieved.

### Embodiments 3

As shown in FIG. 4, a plurality of die structures is connected in series, parallel, or a combination of series and parallel to form a chain light source 400. The chain light source is wound around a main substrate 401 to realize a 4π luminescence (360 omni-directional luminescence) mode, and the main substrate can be shielded in the middle of the chain light source. A specific implementation is as follows:

The chain light source includes a plurality of strip-shaped substrates on which a plurality of connection lines is provided, and each connection line includes the die structures in series or in parallel or in a combination of series and parallel, thereby forming a filament structure. The chain light source on each of the strip-shaped substrates is a light source with a same color temperature or with different color temperatures. Each connection line is independently controlled to control the filament to emit light of a specific color. Specifically, it can be understood that the filament structure formed by a strip substrate may include only one connection line or multiple connection lines.

Based on the above structure, a dimming control scheme of monochrome, bicolor, RGB, RGBW, RGBCW or any combination of colors can be realized with the intelligent driving module.

The main substrate can be in two implementing structures, for one of them, the driving circuit is arranged on the main substrate, the connection line on the strip-shaped substrate is electrically connected with the driving circuit and wound around the main substrate and fixed thereon, and the pin is led out from the main substrate and externally connected to the second seal cavity.

For the other, the main substrate is only used as a fixing bracket, the driving circuit is arranged outside the first seal cavity, and the connection lines on the strip substrate are externally connected to the second seal cavity through the pin.

A plurality of die structure chips is provided on each connection line, and two adjacent die structure chips are connected with each other through a wire or conductive sheet to form a series structure or a parallel structure.

The chain light source is directly exposed to the insulating liquid or the insulating gas in the first seal cavity.

### Embodiments 4

A lens structure is arranged in a housing of the first seal cavity. In another embodiment, a part of the housing of the first seal cavity is in a lens structure, that is, the lens structure as a part of the housing of the first seal cavity is integrally molded with other parts of the housing.

As shown in FIG. 5, the lens structure is a Fresnel lens structure 500, which is located on a divergent surface of the light source and functions to condense light and increases the light efficiency.

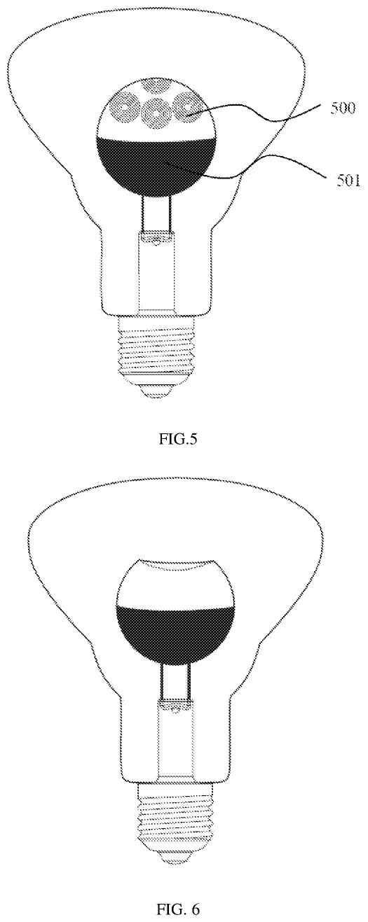

As shown in FIG. 6, in other embodiments, the lens structure is a convex lens structure.

Furthermore, an inner surface of the housing of the first seal cavity is provided with a reflective coating 501, which is sprayed by an aluminum evaporation or made by other processes. However, in order to achieve a same effect, it is necessary to spray a larger area of coating on the lamp shell of the traditional bulb.

In this embodiment, because the first seal cavity can be designed to be very small and directly serves as a light engine, the coating area in the first seal cavity is small and its material consumption can be reduced. According to actual production data, the coating area is only about 1/20 of that of the lamp shell of the traditional bulb.

Similarly, the housing of the first seal cavity is coated with a fluorescent powder or a diffusion powder, and the cost is greatly reduced. Of course, the housing of the second seal cavity can also be coated with the fluorescent powder or the diffusion powder. To sum up, combinations and application modes of the first seal cavity and the second seal cavity can be adapted freely, and the structure with the two sealing cavities can be widely used in different fields.

### Embodiments 5

On the basis of any one of Embodiments 1-4 and further, a heat conducting structure is provided in the first seal cavity, and the heat conducting structure is exposed to the insulating liquid or gas. A shape of the heat conducting structure can be cylindrical, mesh, sheet, wire and other various shapes, as long as it can be fixed in the first seal cavity for heat conducting. Its material can be a metal material, a carbon rod, a graphene material and others with a high thermal conductivity.

From the above embodiments, it is found in applications that the heat in a divergent direction of the light source can be rapidly circulated in a convection process of the insulating liquid or the insulating gas. However, due to different arrangements of the LED chip, there will be a certain temperature difference in the first seal cavity. A penetrating heat conducting structure is arranged on the substrate, and the heat transfer can be accelerated by the heat conducting structure.

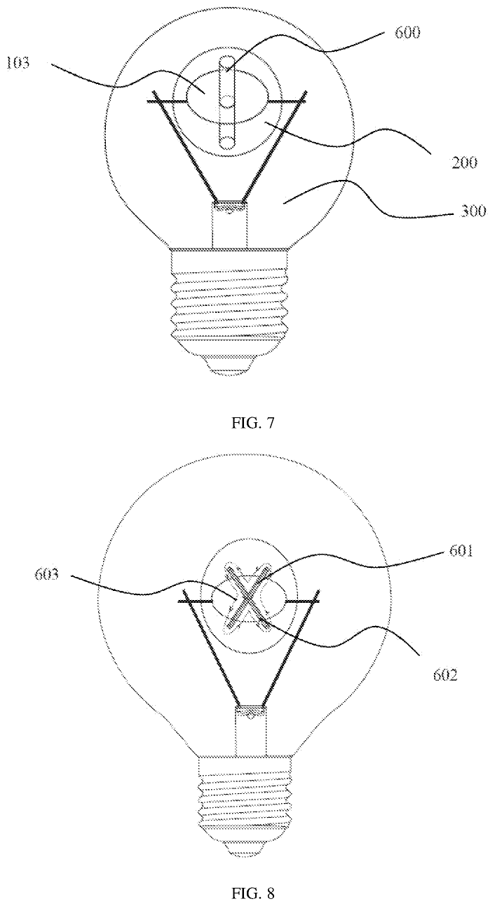

Based on the above factors, as shown in FIGS. 7 and 8, a corresponding heat conducting structure is provided. FIG. 7 is a schematic diagram of the heat conducting structure with a columnar or strip-shaped structure 600 which is fixed on the substrate 103 and passes through the substrate to form an effective heat conducting for a heat concentration part.

As shown in FIG. 8, a heat conducting structure with a cross structure is provided on the substrate, in which a column a 601 and a column b 602 pass through the substrate in an intersecting manner, forming a heat circulation schematic 603 indicated by a dotted line as shown in FIG. 8. Others that needs to be supplemented is as follows:

In other embodiments, the housing of the first seal cavity can also be made of glass, and the housing of the second seal cavity can also be made of silica gel, plastic and other materials with a high light transmittance.

In other embodiments, the first seal cavity can also be filled with the insulating gas, such as helium or the mixed gas with helium. The second seal cavity can also be filled with the insulating liquid. According to different requirements, different applications are transformed.

The above described embodiments only express implementations of the present invention, and their descriptions are more specific and detailed, but they cannot be constructed as limiting a scope of the present invention. It should be noted that, several modifications and improvements can be made by those of ordinary skill in the art without departing from the concept of the present invention, which belong to the protection scope of the present invention.

1. A light-emitting device comprising:
a light engine structure, wherein the light engine structure comprises a light source and a first seal cavity, the light source is provided in the first seal cavity, and the first seal cavity is filled with an insulating liquid or gas, and the light source in the first seal cavity is exposed to the insulating liquid or gas;
a second seal cavity is provided outside the first seal cavity, and the second seal cavity is filled with an insulating liquid or gas; and
the light source comprises a pin which extends from the first seal cavity to the second seal cavity, and the first seal cavity and the second seal cavity are light-permeable seal cavities;
wherein the insulating liquid is a liquid with a high heat capacity and light permeability;
wherein the insulating liquid is a high temperature resistant liquid.

2. The light-emitting device according to claim 1, wherein the light source comprises a plurality of light-emitting diodes and a substrate, the light-emitting diodes are arranged on the substrate and are connected in series, parallel, or a combination of series and parallel, and an end of the pin is connected with the substrate.

3. The light-emitting device according to claim 2, wherein the light source comprises a die structure which is exposed to the insulating liquid or gas in the first seal cavity.

4. The light-emitting device according to claim 2, further comprising a driving circuit which is arranged on the substrate, an end of the pin is connected with the driving circuit, and the other end of the pin is located in the second seal cavity.

5. The light-emitting device according to claim 2, wherein the light source is connected with a driving circuit which is arranged in the second seal cavity, the pin located in the second seal cavity is connected with the driving circuit.

6. The light-emitting device according to claim 3, wherein a plurality of die structures is connected in series, parallel, or a combination of series and parallel to form a chain light source.

7. The light-emitting device according to claim 6, wherein the chain light source is wound around the substrate.

8. The light-emitting device according to claim 6, wherein the chain light source comprises one or more strip-shaped substrates on which the die structures are arranged in series or in parallel or in a combination of series and parallel, and the chain light source on each of the strip-shaped substrates is a light source with a same color temperature or with different color temperatures.

9. The light-emitting device according to claim 1, wherein the light source comprises a plurality of light source groups, and color temperatures of respective ones of the light source groups are the same or different.

10. The light-emitting device according to claim 1, wherein a lens structure is provided in a housing of the first seal cavity, or a part of the housing of the first seal cavity is the lens structure.

11. The light-emitting device according to claim 1, wherein an inner surface of a housing of the first seal cavity is partially provided with a reflective coating.

12. The light-emitting device according to claim 1, wherein a housing of the first seal cavity or a housing of the second seal cavity is provided with a fluorescent powder or a diffusion powder, or a combination of the fluorescent powder and the diffusion powder.

13. (canceled)

14. (canceled)

15. The light-emitting device according to claim 1, wherein a heat conducting structure is provided in the first seal cavity, and the heat conducting structure is exposed to the insulating liquid or gas.

16. The light-emitting device according to claim 1, wherein a housing of the first seal cavity is made of silica gel or plastics, and a housing of the second seal cavity is made of glass.

17. A bulb, comprising one or more light-emitting devices according to claim 1, and further comprising a stem and a base, wherein the base and the stem are connected with a housing of the second seal cavity, the base is used for receiving an external power supply, and a housing of the first seal cavity is fixed on the stem.

18. The bulb according to claim 17, wherein the stem comprises a flare tube, a flare base, an electric lead and an exhaust pipe, the exhaust pipe is arranged in the flare tube, the flare base is hermetically connected to the second seal cavity; and an end of the electric lead is connected to the base and the other end of the electric lead is connected to the pin.

19. The bulb according to claim 17, further comprising a driving circuit, the driving circuit is installed in the base, or in the first seal cavity, or in the second seal cavity.

20. The bulb according to claim 17, further comprising an intelligent driving module installed in the base, and the intelligent driving module comprises a controller and a communication module.
